(19) United States
(12) Patent Application Publication
(10) Pub. No.: US 2025/0056266 A1
(43) Pub. Date: Feb. 13, 2025

(54) NETWORK CAPACITY AUGMENTATION BASED ON CAPACITY UTILIZATION DATA AND USING MOBILE NETWORK ACCESS NODES

(71) Applicant: T-Mobile USA, Inc., Bellevue, WA (US)

(72) Inventors: Roopesh Kumar Polaganga, Bothell, WA (US); Sanjay Baburao Waje, Plano, TX (US)

(21) Appl. No.: 18/366,554

(22) Filed: Aug. 7, 2023

(51) Int. Cl. H04W 24/08; H04W 16/22; H04W 48/16; H04W 64/00

(52) U.S. Cl. CPC H04W 24/08; H04W 16/22; H04W 48/16; H04W 64/00; H04W 84/005

(57) ABSTRACT

The disclosed technology obtains network data of one or more network access nodes of a telecommunications network and determines a need for capacity augmentation for the one or more network access nodes. Based on the need for capacity augmentation, navigation instructions are generated for one or more mobile network access nodes. Based on the navigation instructions, the one or more mobile network access nodes are caused to relocate to a particular location of a target site at a particular time and provide the capacity augmentation for a particular duration.

### BACKGROUND

A cell on wheels (COW), or site on wheels, is a telecom infrastructure placed on a trailer approved for road use and towed by a heavy goods vehicle, which is a vehicle with a total weight, including its load, of up to 3500 kg. COWs guarantee full operation in just one day and in restricted spaces. COWs are used to provide expanded cellular network coverage and/or capacity for short-term demands, such as at major sporting events and other special events. COWs provide fully functional service via vehicles such as trailers, vans, and trucks. The backhaul to the network can be via terrestrial microwave, communication satellite, or existing wired infrastructure.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates a modified wireless communications system implementing aspects of the present technology.

FIG. 3 is a flowchart of an implementation of a process for obtaining network data from a network access node (NAN) and feeding the network data and instructions to an autonomous NAN.

FIG. 4 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Network operators face challenges involving network capacity planning. Prediction of customer usage information is difficult because customer usage varies depending on various factors, such as busy hour variations, special events, unexpected network outages, and ongoing network changes. Traditional approaches for addressing the capacity needs of customers involve manually reviewing key performance indicator metrics and configuring future capacity planning without mitigating customer needs on a real-time basis. The disclosed technologies address the problems by taking advantage of uncrewed vehicles that function as mobile network access nodes (MNANs) to provide additional or replacement capacity to serve immediate customer needs.

In one embodiment, a server obtains network data from existing, often stationary, network access nodes (NANs). The NANs periodically collect and monitor network data associated with cell locations of the NANs. The network data includes capacity information of a NAN in a cell location, utilization information of the NAN based on time information, and location information of endpoint devices that utilize capacity of the NAN. In response to receiving the network data from the existing NANs, the server analyzes the network data to determine a need for capacity augmentation for cell locations associated with the existing NANs. The server then generates instructions that dispatch uncrewed vehicles that function as MNANs to the cell locations with the need for capacity augmentation.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

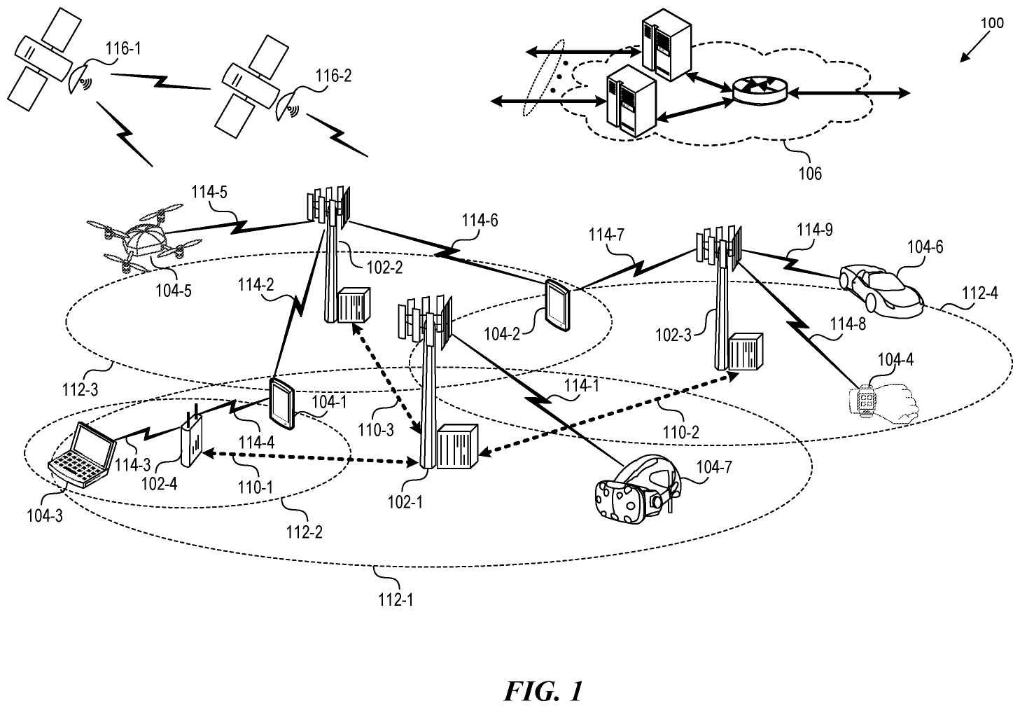

FIG. 1 is a block diagram that illustrates a wireless telecommunications network 100 (“network 100”) in which aspects of the disclosed technology are incorporated. The network 100 includes base stations 102-1 through 102-4 (also referred to individually as “base station 102” or collectively as “base stations 102”). A base station is a type of NAN that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104-1 through 104-7 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The geographic coverage area 112 for a base station 102 can be divided into sectors making up only a portion of the coverage area (not shown). The network 100 can include base stations of different types (e.g., macro and/or small cell base stations). In some implementations, there can be overlapping geographic coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term eNB is used to describe the base stations 102, and in 5G new radio (NR) networks, the term gNBs is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communications networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the system 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances, etc.

A wireless device (e.g., wireless devices 104-1, 104-2, 104-3, 104-4, 104-5, 104-6, and 104-7) can be referred to as a user equipment (UE), a customer premise equipment (CPE), a mobile station, a subscriber station, a mobile unit, a subscriber unit, a wireless unit, a remote unit, a handheld mobile device, a remote device, a mobile subscriber station, terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102, and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites such as satellites 116-1 and 116-2 to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service requirements and multi-terabits-per-second data transmission in the 6G and beyond era, such as terabit-per-second backhaul systems, ultrahigh-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

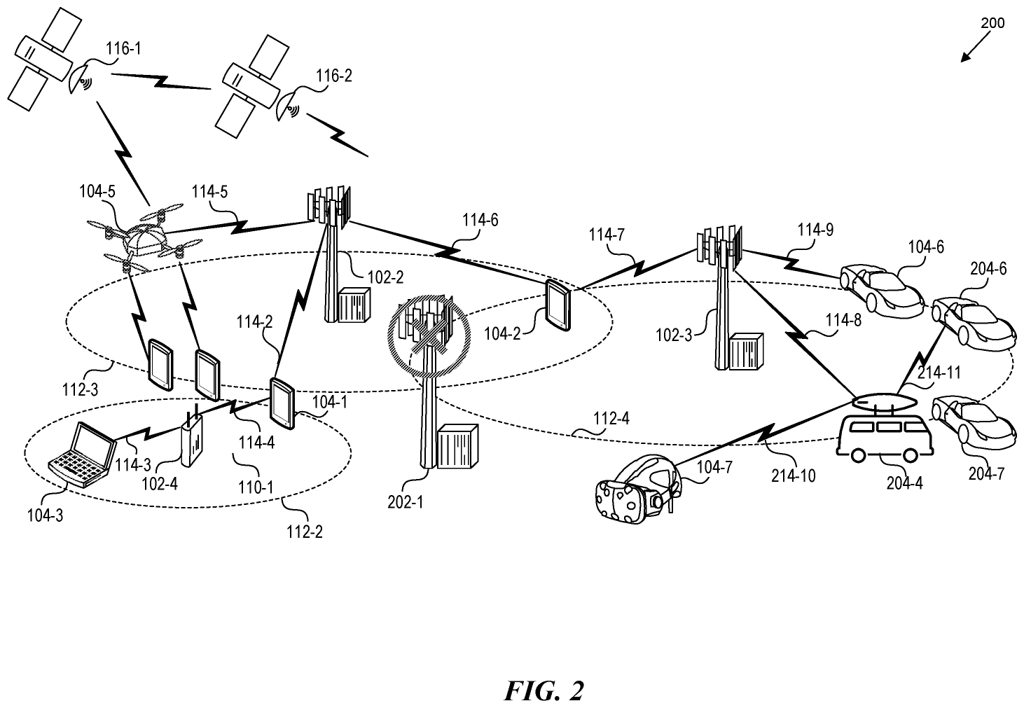

FIG. 2 is a block diagram that illustrates a modified wireless communications network 200 (“network 200”) in which aspects of the disclosed technology are incorporated. The network 200 includes base stations 102-2 through 102-4 and may also include one or more base stations that are inoperable, as exemplified by base station 202-1. The base station 202-1 can be deemed inoperable due to various reasons, such as technical failure, routine maintenance, or unexpected events such as natural disasters or power failures.

Inoperable NANs, such as the base station 202-1, can affect communication coverage for geographic coverage areas where the inoperable NANs are located. In the network 200, geographic coverage areas 112-3 and 112-4 are affected by the inoperable base station 202-1. In some implementations, because wireless devices with service subscriptions with a wireless network 200 service provider can no longer access the base station 202-1, other operable NANs located in the affected geographic coverage areas become responsible for providing wireless services to the wireless devices. However, each NAN has an associated capacity that indicates the maximum amount of network traffic or wireless devices that can utilize services of the NAN. As such, the increased utilization of the operable NANs due to existence of the inoperable NANs in the affected geographic coverage areas creates a need for capacity augmentation to reconfigure how the wireless services are provided to the wireless devices.

One solution associated with capacity reconfiguration includes dispatching MNANs, such as MNAN 204-4. The MNAN 204-4 can be a NAN disposed on an uncrewed vehicle. As shown in network 200, in response to a need for capacity augmentation in the geographic coverage area 112-4 due to the inoperable NAN 202-1, the MNAN 204-4 is dispatched to the geographic coverage area 112-4. The MNAN 204-4 communicates with existing base station 102-3 to provide wireless services to wireless devices in the geographic coverage area 112-4. For example, wireless device 104-7, which originally received access to wireless services through the now inoperable NAN 202-1, now receives access to wireless services through the MNAN 204-4, as shown by communication link 214-10. In some implementations, the MNANs are fully autonomous such that the vehicles are automatically dispatched and navigate to affected geographic coverage areas in response to the network 200 requiring increased capacity.

The network 200 can require capacity augmentation for other reasons, such as busy time variations or special events occurring within an affected geographic coverage area that necessitate capacity needs in addition to existing NANs located in the affected geographic coverage area. In some implementations, the network 200 responds proactively to the additional capacity needs by predicting increased usage and dispatching the MNANs accordingly. Unexpected events, such as unexpected network outages, power failures, and natural disasters, can also create a need for additional MNANs in the affected geographic coverage area.

In some implementations, the network 200 can dispatch the MNAN based on real-time needs of the wireless devices that utilize the capacity of the existing NANs in the geographic coverage area. For example, wireless device 204-6 of network 200 can send a signal to the base station 102-3 indicating that the wireless device 204-6 is experiencing subpar quality of service. Another wireless device 204-7, which is in the vicinity of the wireless device 204-6, can also send a signal indicating deteriorated wireless service. In response to receiving the signals from the wireless devices 204-6 and 204-7, the network 200 dispatches the MNAN 204-4 to a location that results in improved coverage to the wireless devices 204-6 and 204-7 through communication links such as communication link 214-11.

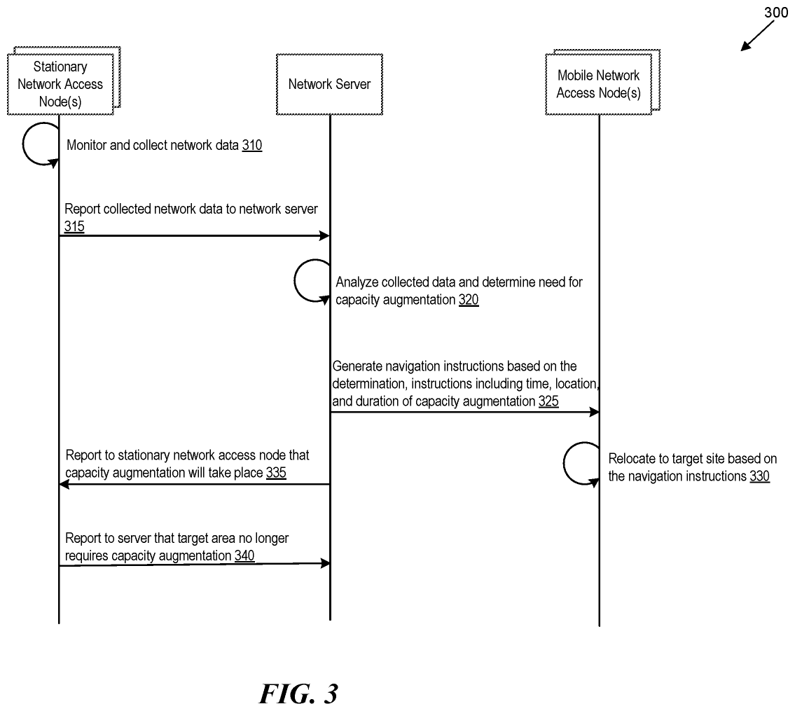

FIG. 3 is a flowchart of an implementation of a process 300 for obtaining network data from a NAN and feeding the network data and instructions to an autonomous NAN in a telecommunications network. The process 300 can be performed by a system including a network server, in some implementations. Other implementations of the process 300 include additional, fewer, or different operations or perform the operations in different orders.

At 310, one or more stationary network access nodes (SNANs) monitor and collect network data. The one or more SNANs may refer to various types of NANs of the telecommunications network, such as base stations, base transceiver stations, or radio base stations. The one or more SNANs are designed to be stationary and provide wireless services to subscribers of the telecommunications network in corresponding geographic coverage areas. The size of the geographic coverage areas associated with the one or more SNANs can vary depending on capabilities of the corresponding SNANs.

The network data monitored and collected by the one or more SNANs can include capacity information of the one or more SNANs. For example, a SNAN with greater physical volume and technical capabilities has greater capacity and is thus able to provide wireless services to a greater number of subscribers. The network data can also include utilization information of the SNANs, such as a percentage of the maximum capacity of the SNANs being utilized to provide wireless services to the subscribers. The network data can also include location data of subscribers that are utilizing capacities of the SNANs at a given period of time.

In some implementations, the network data of the SNANs is monitored and collected at preconfigured intervals. The preconfigured intervals may vary depending on factors including the size of the geographic coverage area associated with a given SNAN, historical data showing subscriber utilization over time, and time of the day. For example, based on the historical data showing a trend of greater utilization of a SNAN located near a popular beach, the SNAN may be configured to monitor and collect network data every ten minutes during summer, while the same SNAN may be configured to monitor and collect network data every hour during winter when there is less traffic. In another example, based on data showing that subscriber utilization is at peak after hours from 9:00 p.m. to 12:00 a.m. compared to daytime, a SNAN may be configured to monitor and collect network data every thirty minutes during peak hours as compared to monitoring and collecting network data every hour during off-peak hours.

At 315, the collected network data is reported to the network server. The network server may save the collected network data in a memory that can be local or remote. In some implementations, the entirety of the collected network data is saved in the memory. In other implementations, the network server applies a rule-based model or a machine learning (ML) model to assign priorities to the collected network data and determines whether a part or all of the collected network data is to be saved in the memory.

At 320, the network server analyzes the collected network data and determines the need for capacity augmentation. The need for capacity augmentation may refer to any changes that are needed to provide wireless services to the subscribers of the telecommunications network. In some implementations, the need for capacity augmentation is determined based on notifications from endpoint devices of the subscribers that reflect real-time needs for increased network capacity. The notifications may be delivered via a mobile application operated by the network server and installed on the endpoint devices. Additionally or alternatively, the notifications may be phone calls made from the endpoint devices to a hotline or customer service center of the telecommunications network.

In other implementations, the need for capacity augmentation is determined in response to the one or more SNANs becoming inoperable. The SNANs of the telecommunications network may become inoperable due to various expected and/or unexpected factors. Expected factors include capacity overload due to increased wireless traffic. For example, a NAN that is providing wireless services to subscribers and is operating at maximum capacity receives a sudden influx of service requests from additional subscribers located within the geographic coverage area associated the SNAN. Because the SNAN has already exhausted all resources to provide wireless services to existing subscribers, the SNAN can no longer handle incoming service requests. Additionally, network overload causes the SNAN to fail entirely and become inoperable. Expected factors may also include deliberate shutdown of SNANs in order to implement new features and/or software updates. The updates may occur in different times for different geographic coverage areas based on historical data of subscriber utilization in order to minimize the number of subscribers being affected by inoperable SNANs.

Examples of unexpected factors include network outages or power failures that result in inoperable SNANs. Unexpected factors may also include natural disasters directly impacting operability of the SNANs.

In some implementations, the network server determines the need for capacity augmentation using an ML model. A “model,” as used herein, can refer to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include neural networks, support vector machines, decision trees, Parzen windows, Bayes, clustering, reinforcement learning, probability distributions, decision trees, decision tree forests, and others. Models can be configured for various situations, data types, sources, and output formats.

One or more of the ML models described herein can be trained with supervising learning, where the training data includes historical data of subscriber utilization of the SNANs as input and a desired output, such as the need for capacity augmentation for the associated SNANs. Additionally or alternatively, in some implementations, the collected network data stored in one or more memories of the telecommunications network can be provided to the ML model to allow the ML model to learn more information about the relationship between subscriber usage information and the need for capacity augmentation. In some implementations, the ML model predicts an onset of capacity constraints associated with the SNANs. Based on the onset of the capacity constraints, the ML model determines the need for capacity augmentation. For example, based on historical data showing increased demand for capacity from subscribers in peak hours between 9:00 p.m. and 10:00 p.m. followed by shutdowns of associated SNANs due to network overload, the ML model may predict that increased demand at peak hours in the future will likely result in NAN failures and determine that capacity augmentation is needed preemptively to prevent the SNANs from failing.

In some implementations, the ML model is trained to distinguish expected capacity constraints from unexpected capacity constraints. For example, expected capacity constraints result from expected events, such as busy hour surge in wireless traffic, special events or gatherings taking place within a geographic coverage area resulting in a crowd as well as increased demand for wireless services in the geographic coverage area, or expected periodic maintenance activities that result in SNAN downtimes. Unexpected capacity constraints may result from unexpected events, such as a natural disaster causing site power failures and unexpected network outages. The ML model may be trained to distinguish expected capacity constraints from unexpected capacity constraints for the network server to correspond to accordingly.

In other implementations, the network server may determine the need for capacity augmentation by assigning a numerical value between 0 and 1 that represents severity of the need for capacity augmentation corresponding to each event of the collected network data. The event may be identified by time, i.e., event 1 corresponding to all activities associated with subscriber capacity utilization between 5:00 p.m. and 6:00 p.m., and event 2 corresponding to all activities associated with subscriber capacity utilization between 6:00 p.m. and 7:00 μm. The event may also be identified in response to sudden changes in subscriber capacity utilization. For example, a sudden increase in subscriber capacity utilization triggers the network server to mark the sudden increase as an event with a corresponding numerical value representing severity of the need for capacity augmentation.

In some implementations, the numerical values assigned to the events are compared to a predetermined threshold. If the numerical value for an event is below the predetermined threshold, the network server may determine that the associated SNAN has capacity to handle subscriber requests and that there is no need for capacity augmentation. If the numerical value for the event is at or above the predetermined threshold, the network server may determine that the associated SNAN is incapable of handling subscriber requests and determines that an additional capacity is needed. Following the determination, the network server may determine that an MNAN is needed at the geographic coverage area associated with the SNAN in need of capacity augmentation.

In other implementations, the numerical values assigned to the events are compared to multiple predetermined thresholds. For example, if the numerical value for an event is below a first predetermined threshold, the network server determines that the associated SNAN has capacity to handle subscriber requests, and no further action is taken to supplement the SNAN. If the numerical value for the event is at or above the first predetermined threshold but below a second predetermined threshold, the network server may determine that the need for capacity augmentation is not severe and that only one additional MNAN is sufficient to supplement the SNAN at the geographic coverage area. If the numerical value for the event is at or above the second predetermined threshold, the network server may determine that the need for capacity augmentation is severe and that multiple MNANs are needed at the geographic coverage area.

At 325, upon determining that one or more MNANs are needed at a geographic coverage area of the SNAN with identified need for capacity augmentation, the network server generates navigation instructions for the one or more MNANs. The MNANs are mobile cell sites that can be deployed to support sudden increases in mobile traffic in affected geographic coverage areas. The MNANs can provide prompt support in response to the need for capacity augmentation because the MNANs are disposed on vehicles, which are often uncrewed. In some implementations, the navigation instructions include a particular time, a particular location, and a particular duration of the capacity augmentation corresponding to the determination of need for capacity augmentation. For example, after determining that a SNAN at a venue requires capacity augmentation due to an upcoming concert where increase in mobile traffic is inevitable, the network server generates navigation instructions for one or more MNANs. The navigation instructions may contain information such as an address of the venue, time of the concert, and duration of the concert.

At 330, in response to receiving the navigation instructions from the network server, the one or more MNANs are relocated to a target site within the geographic coverage area of the SNAN with identified need for capacity augmentation. In some implementations, the MNANs are configured to autonomously navigate to the particular location contained in the navigation instructions in response to receiving the navigation instructions from the network server. In other implementations, the MNANs are configured to be remotely controlled by personnel of the network server.

In some implementations, after generating the navigation instructions based on the determination of need for capacity augmentation, the network server sends a report to the SNAN with the identified need that capacity augmentation will take place, as shown in 335. In other implementations, after determining that the one or more MNANs are no longer needed, the SNAN with the originally identified need sends a report to the network server that the geographic coverage area no longer requires capacity augmentation, as shown in 340. The SNAN may determine that the one or more MNANs are no longer needed based on a decrease in incoming subscriber requests.

### Computer System

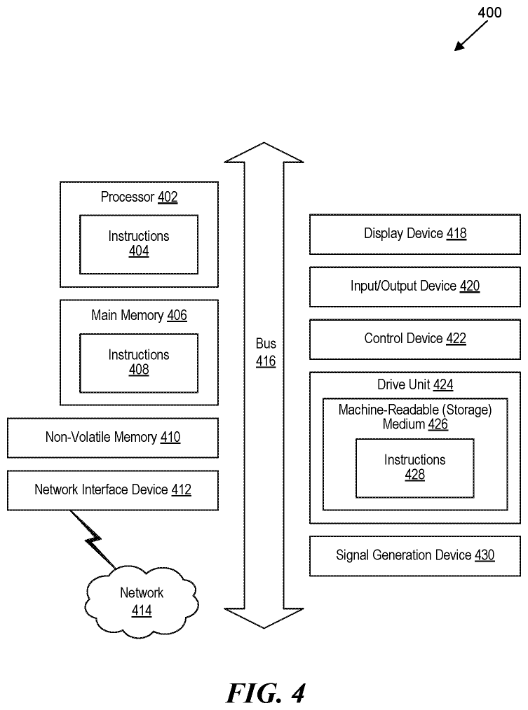

FIG. 4 is a block diagram that illustrates an example of a computer system 400 in which at least some operations described herein can be implemented. As shown, the computer system 400 can include: one or more processors 402, main memory 406, non-volatile memory 410, a network interface device 412, a video display device 418, an input/output device 420, a control device 422 (e.g., keyboard and pointing device), a drive unit 424 that includes a storage medium 426, and a signal generation device 430 that are communicatively connected to a bus 416. The bus 416 represents one or more physical buses and/or point-to-point connections that are connected by appropriate bridges, adapters, or controllers. Various common components (e.g., cache memory) are omitted from FIG. 4 for brevity. Instead, the computer system 400 is intended to illustrate a hardware device on which components illustrated or described relative to the examples of the figures and any other components described in this specification can be implemented.

The computer system 400 can take any suitable physical form. For example, the computer system 400 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computer system 400. In some implementations, the computer system 400 can be an embedded computer system, a system-on-chip (SOC), a single-board computer system (SBC), or a distributed system such as a mesh of computer systems, or can include one or more cloud components in one or more networks. Where appropriate, one or more computer systems 400 can perform operations in real time, in near real time, or in batch mode.

The network interface device 412 enables the computer system 400 to mediate data in a network 414 with an entity that is external to the computer system 400 through any communication protocol supported by the computer system 400 and the external entity. Examples of the network interface device 412 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 406, non-volatile memory 410, machine-readable medium 426) can be local, remote, or distributed. Although shown as a single medium, the machine-readable medium 426 can include multiple media (e.g., a centralized/distributed database and/or associated caches and servers) that store one or more sets of instructions 428. The machine-readable (storage) medium 426 can include any medium that is capable of storing, encoding, or carrying a set of instructions for execution by the computer system 400. The machine-readable medium 426 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 410, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 404, 408, 428) set at various times in various memory and storage devices in computing device(s). When read and executed by the processor 402, the instruction(s) cause the computer system 400 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A method performed by a network server, the method comprising:
obtaining network data of one or more network access nodes of a telecommunications network,
wherein the network data includes one or more of:
capacity information of the one or more network access nodes,
utilization information of the one or more network access nodes, and
location data of endpoint devices that utilize capacity of the one or more network access nodes;
determining a need for capacity augmentation for the one or more network access nodes;
generating, based on the need for capacity augmentation, navigation instructions for one or more mobile network access nodes,
wherein the navigation instructions include a particular time, a particular location, and a particular duration of the capacity augmentation for a target site, and
wherein each of the one or more mobile network access nodes is disposed on an uncrewed vehicle; and
causing, based on the navigation instructions, the one or more mobile network access nodes to relocate to the particular location of the target site at the particular time and provide the capacity augmentation for the particular duration.

2. The method of claim 1, wherein the network data is obtained at preconfigured intervals from the one or more network access nodes.

3. The method of claim 1, wherein the need for capacity augmentation is determined based on real-time needs of the endpoint devices that utilize the capacity of the one or more network access nodes.

4. The method of claim 1, wherein the need for capacity augmentation is determined in response to the one or more network access nodes becoming inoperable.

5. The method of claim 1, wherein the need for capacity augmentation is determined by a machine learning (ML) model and further comprises:
training the ML model with the obtained network data of the one or more network access nodes;
predicting, by the ML model, an onset of capacity constraints associated with the one or more network access nodes; and
based on the predicted onset of capacity constraints, determining the need for capacity augmentation.

6. The method of claim 5, wherein the ML model is trained to distinguish expected capacity constraints from unexpected capacity constraints.

7. The method of claim 1, wherein determining the need for capacity augmentation further comprises:
when the need for capacity augmentation is below a first threshold, determining that no mobile network access node is needed;
when the need for capacity augmentation is at or above the first threshold and below a second threshold, determining that one mobile network access node is needed; and
when the need for capacity augmentation is at or above the second threshold, determining that multiple mobile network access nodes are needed.

8. The method of claim 1, wherein the one or more mobile network access nodes are configured to autonomously navigate to the particular location.

9. The method of claim 1, wherein the one or more mobile network access nodes are remotely controlled to navigate to the particular location.

10. The method of claim 1, wherein the navigation instructions are modified based on real-time traffic information based on the particular time and the particular location.

11. A non-transitory, computer-readable storage medium comprising instructions recorded there on, wherein the instructions when executed by at least one data processor of a system, cause the system to:
obtain network data of one or more network access nodes of a telecommunications network,
wherein the network data includes one or more of:
capacity information of the one or more network access nodes,
utilization information of the one or more network access nodes, or
location data of endpoint devices that utilize capacity of the one or more network access nodes;
determine a need for capacity augmentation for the one or more network access nodes;
generate, based on the need for capacity augmentation, navigation instructions for one or more mobile network access nodes,
wherein the navigation instructions include a particular time, a particular location, or a particular duration of the capacity augmentation for a target site; and
cause, based on the navigation instructions, the one or more mobile network access nodes to relocate to the particular location of the target site at the particular time and provide the capacity augmentation for the particular duration.

12. The non-transitory, computer-readable storage medium of claim 11, wherein the need for capacity augmentation is determined based on real-time needs of the endpoint devices that utilize the capacity of the one or more network access nodes.

13. The non-transitory, computer-readable storage medium of claim 11, wherein the need for capacity augmentation is determined by a machine learning (ML) model, and wherein the system is further caused to:
train the ML model with the obtained network data of the one or more network access nodes;
predict, by the ML model, an onset of capacity constraints associated with the one or more network access nodes; and
based on the predicted onset of capacity constraints, determine the need for capacity augmentation.

14. The non-transitory, computer-readable storage medium of claim 11, wherein determining the need for capacity augmentation further comprises causing the system to:
when the need for capacity augmentation is at or above a threshold, determine that an additional mobile network access node is needed.

15. The non-transitory, computer-readable storage medium of claim 11, wherein the navigation instructions are modified based on real-time factors including traffic information and weather information based on the particular time and the particular location.

16. A system comprising:
at least one hardware processor; and
at least one non-transitory memory storing instructions, which, when executed by the at least one hardware processor, cause the system to:
obtain network data of one or more network access nodes of a telecommunications network,
wherein the network data includes capacity information of the one or more network access nodes;
determine a need for capacity augmentation for the one or more network access nodes;
generate, based on the need for capacity augmentation, navigation instructions for one or more mobile network access nodes,
wherein the navigation instructions include a particular time, a particular location, or a particular duration of the capacity augmentation for a target site; and
cause, based on the navigation instructions, the one or more mobile network access nodes to relocate to the particular location of the target site at the particular time and provide the capacity augmentation for the particular duration.

17. The system of claim 16, wherein the need for capacity augmentation is determined based on real-time needs of endpoint devices that utilize capacity of the one or more network access nodes.

18. The system of claim 16, wherein the need for capacity augmentation is determined by a machine learning (ML) model, wherein determining the need for capacity augmentation further comprises causing the system to:
train the ML model with the obtained network data of the one or more network access nodes;
predict, by the ML model, an onset of capacity constraints associated with the one or more network access nodes; and
based on the predicted onset of capacity constraints, determine the need for capacity augmentation.

19. The system of claim 16, wherein determining the need for capacity augmentation further comprises causing the system to:
when the need for capacity augmentation is at or above a threshold, determine that an additional mobile network access node is needed.

20. The system of claim 16, wherein the navigation instructions are modified based on real-time factors including traffic information and weather information based on the particular time and the particular location.
